(19) United States
(12) Patent Application Publication
(10) Pub. No.: US 2019/0371022 A1
(43) Pub. Date: Dec. 5, 2019

(54) METHOD ANDAPPARATUS FOR PROCESSING MULTIMEDIA DATA, AND DEVICE THEREFOR

(71) Applicant: UCWEB SINGAPORE PTE. LTD., Singapore (SG)

(72) Inventors: Yuepeng HU, Beijing (CN); Chaonan SUN, Beijing (CN)

(21) Appl. No.: 16/138,896

(22) Filed: Sep. 21, 2018

Related U.S. Application Data
(63) Continuation of application No. PCT/CN2018/089357, filed on May 31, 2018.

(51) Int. Cl. G06T 11/60; G06K 9/00; H04L 29/08

(52) U.S. Cl. CPC G06T 11/60; H04L 67/306; G06K 9/00671

(57) ABSTRACT

A method and an apparatus for processing multimedia data, and a device therefor are provided. The method includes: acquiring, by a first user terminal, multimedia content shared by a second user terminal; performing a target detection for the multimedia content to acquire a target detection result, wherein the target detection comprises a profile information detection for the multimedia content; and generating an augmented reality object according to the target detection result and an image acquired by the first user terminal, and exhibiting the augmented reality object. According to the embodiments of the present application, interactions between users may be effectively implemented, and interaction effects are improved.

### CROSS-REFERENCE TO RELATED DISCLOSURES

The present disclosure is a continuation of international disclosure No. PCT/CN2018/089357 filed on May 31, 2018, which is hereby incorporated by reference in its entirety.

### TECHNICAL FIELD

Embodiments of the present disclosure relate to the technical field of Internet, and in particular, relate to a method and apparatus for processing multimedia data, and a device/terminal/server therefor.

### BACKGROUND

With the development of the Internet technologies, sharing of multimedia content has become one important tool for extending social networks. Users interact with other users using the multimedia content sharing means such as video sharing and the like, such that content-based social networking is practiced. At present, the sharing of the multimedia content is mainly practiced by using an instant messaging tool or the like social networking software. However, the current sharing of the multimedia content is mainly practiced by means of watching and commenting played multimedia content.

Therefore, how to practice effective interactions between users by processing the multimedia content is a technical problem to be urgently solved in the prior art.

### SUMMARY

Embodiments of the present disclosure provide a method and apparatus for processing multimedia data, and a device/terminal/server therefor, to solve the above technical problem in the prior art.

According to one aspect of embodiments of the present disclosure, a method for processing multimedia data is provided. The method includes: acquiring, by a first user terminal, multimedia content shared by a second user terminal; performing a target detection for the multimedia content to acquire a target detection result, wherein the target detection includes a profile information detection for the multimedia content; and generating an augmented reality (AR) object according to the target detection result and an image acquired by the first user terminal, and exhibiting the AR object.

According to another aspect of embodiments of the present disclosure, an apparatus for processing multimedia data is provided. The apparatus includes: an acquiring module, configured to acquire multimedia content shared by a second user terminal; a detecting module, configured to perform a target detection for the multimedia content to acquire a target detection result, wherein the target detection includes a profile information detection for the multimedia content; and a generating module, configured to generate an augmented reality (AR) object according to the target detection result and an image acquired by the first user terminal, and exhibit the AR object.

According to still another aspect of embodiments of the present disclosure, a device/terminal/server is further provided. The device/terminal/server includes: one or more processors; and a memory, configured to store one or more programs; where the one or more programs, when being executed by the one or more processors, cause the one or more processors to perform the method for processing multimedia data as described above.

According to yet still another aspect of embodiments of the present disclosure, a computer-readable storage medium is further provided. The computer-readable storage medium stores a computer program; wherein the computer program, when being executed by a processor, causes the processor to perform the method for processing multimedia data as described above.

In the technical solutions according to embodiments of the present disclosure, a first user terminal performs a target detection, including a profile information detection, for multimedia content to acquire a corresponding target detection result (including profile information of the multimedia content), and thus a corresponding AR object is generated according to an image acquired by the first user terminal and the target detection result. The profile information may indicate information of a multimedia profile used when the second user terminal generates the multimedia content. Through the profile information, feature information such as facial expressions, emotions, scenarios and the like that are shared by a user of the second user terminal via the multimedia content may be acknowledged, such that a user of the first user terminal generates an AR object similar to or matching a style of the shared multimedia content. In this way, a better expression effect is achieved, interactions between users may be implemented via the AR object, and interaction effects may be improved.

### BRIEF DESCRIPTION OF THE DRAWINGS

FIG. 1 is a flowchart illustrating steps of a method for processing multimedia data according to the first embodiment of the present disclosure;

FIG. 2 is a flowchart illustrating steps of a method for processing multimedia data according to the second embodiment of the present disclosure;

FIG. 3 is a schematic diagram illustrating one result of processing multimedia data according to the embodiment as illustrated in FIG. 2;

FIG. 4 is a schematic diagram illustrating another result of processing multimedia data according to the embodiment as illustrated in FIG. 2;

FIG. 5 is a schematic structural diagram of an apparatus for processing multimedia data according to the third embodiment of the present disclosure;

FIG. 6 is a schematic structural diagram of an apparatus for processing multimedia data according to the fourth embodiment of the present disclosure; and

FIG. 7 is a schematic structural diagram of a device/terminal/server according to the fifth embodiment of the present disclosure.

### DETAILED DESCRIPTION

The specific embodiments of the present disclosure are further described in detail with reference to the accompanying drawings (in the several drawings, like reference numerals denote like elements). The following embodiments are merely intended to illustrate the present disclosure, but are not intended to limit the scope of the present disclosure.

A person skilled in the art may understand that the terms “first”, “second” and the like in the embodiments of the present disclosure are only used to distinguish different steps, devices or modules or the like, and do not denote any specific technical meaning or necessary logical sequence therebetween.

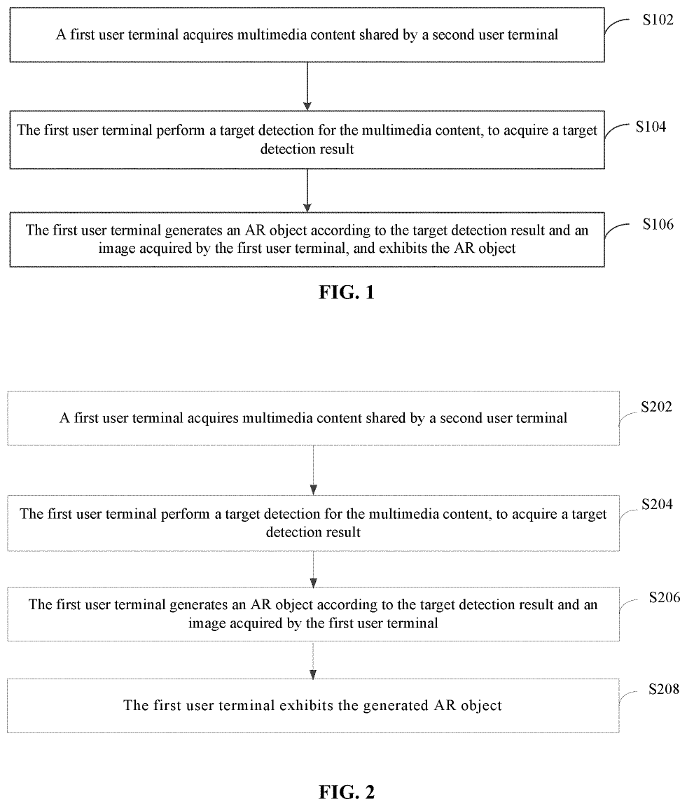

Referring to FIG. 1, a flowchart illustrating steps of a method for processing multimedia data according to the first embodiment of the present disclosure is given.

The method for processing multimedia data according to this embodiment includes the following steps:

Step S102: A first user terminal acquires multimedia content shared by a second user terminal.

In the embodiment of the present disclosure, the multimedia content generated according to corresponding profile information is mainly processed. That is, the multimedia content shared by the second user terminal is generated according to the profile information.

The multimedia content includes, but not limited to: images, audios, videos, texts, ARs, special effects and the like.

The profile information is used to provide information of a photographing profile observing a specific rule, to generate multimedia content having a corresponding subject or style or mode, for example, various magic expression profiles, various scenarios or script profiles or the like. In addition to the specific rule, optionally, the profile information may further include at least one of a predetermined text, image, audio and video.

Step S104: The first user terminal perform a target detection for the multimedia content, to acquire a target detection result.

The target detection includes a profile information detection for the multimedia content to acquire profile information used by the multimedia content. Further, according to the profile information, feature information to be shared by a sharer may be acknowledged, for example, expressions, emotions, scenarios and the like.

Step S106: The first user terminal generates an AR object according to the target detection result and an image acquired by the first user terminal, and exhibits the AR object.

After the profile information used by the multimedia content is acquired, the user of the first user terminal may acquire corresponding images by using an image acquisition device of the first user terminal, including but not limited to images of the user, to match the shared multimedia content to generate the AR object and exhibit the generated AR object.

For example, if the target detection result indicates that the multimedia content uses a large smile magic expression profile, the multimedia content may be combined with a funny scenario of the first user terminal to generate the corresponding AR object; or facial images of the user of the first user terminal are acquired, the facial images in the original multimedia content are replaced with the acquired facial images, and a large smile magic expression of the user of the first user terminal is generated in combination with the large smile magic expression profile; or facial images of the user of the first user terminal are acquired, a large smile magic expression of the user of the first user terminal is generated in combination with the large smile magic expression profile, and the AR object is generated by combining the large smile magic expression of the user of the first user with a large smile magic expression shared by the second user terminal, and the like.

According to this embodiment, a first user terminal performs a target detection, including a profile information detection, for multimedia content to acquire a corresponding target detection result (including profile information of the multimedia content), and thus a corresponding AR object is generated according to an image acquired by the first user terminal and the target detection result. The profile information may indicate information of a multimedia profile used when the second user terminal generates the multimedia content. Through the profile information, feature information such as expressions, emotions, scenarios and the like that are shared by a user of the second user terminal via the multimedia content may be acknowledged, such that a user of the first user terminal generates an AR object similar to or matching a style of the shared multimedia content. In this way, a better expression effect is achieved, interactions between users may be implemented via the AR object, and interaction effects may be improved.

The method for processing multimedia data according to this embodiment may be performed by any device having the data processing capability, including, but not limited to: various terminal devices or servers, for example, PCs, tablet computers, mobile terminals or the like.

Referring to FIG. 2, a flowchart illustrating steps of a method for processing multimedia data according to the second embodiment of the present disclosure is given.

The method for processing multimedia data according to this embodiment includes the following steps:

Step S202: A first user terminal acquires multimedia content shared by a second user terminal.

As described above, in the embodiment of the present disclosure, the multimedia content generated according to corresponding profile information is mainly processed. That is, the multimedia content shared by the second user terminal is generated according to the profile information as described in the first embodiment.

The multimedia content includes, but not limited to: images, audios, videos, texts, ARs, special effects and the like. The multimedia content may be multimedia content that is photographed by a user using the second user terminal, or may be multimedia content that is downloaded by the user over the Internet or locally stored.

The multimedia content shared by the second user terminal may be directed to the first user terminal, or may be directed to a user terminal in a specific range or a non-specific range.

Step S204: The first user terminal perform a target detection for the multimedia content, to acquire a target detection result.

The target detection includes a profile information detection for the multimedia content. As described above, the profile information is used to provide the information of the photographing profile observing the specific rule, to generate the multimedia content having the corresponding subject, style or mode.

In a possible implementation, the profile information detection may be performed for the multimedia content using a transmission protocol based on which the second user terminal shares the multimedia content, to acquire a detection result. The multimedia content profile information is carried in the transmission protocol. The multimedia content receiving party may acquire the corresponding profile information without installing the disclosure software for generating the multimedia content, such that local multimedia content matching or corresponding to the received multimedia content may be generated. In this way, effective information interaction between the users is implemented while the operation load of the multimedia content receiving party is mitigated.

The transmission protocol that carries the profile information may be any suitable protocol, including, but not limited to, the HTTP protocol. For example, a multimedia content sending party codes the multimedia content profile information, for example, coding “magic expression: A”, “facial treatment: enable”, and “music: X” respectively, and carrying the coding information in the HTTP protocol. The multimedia content receiving party parses the transmission protocol to acquire the coding information therein, hence acquire the corresponding profile information from the corresponding server according to the coding information, and finally, performs corresponding operations according to the profile information. The specific coding rule and manner may be implemented in any suitable manner by a person skilled in the art according to the actual needs and the requirements of the used transmission protocol, which is not limited in the embodiment of the present disclosure.

Optionally, the performing a profile information detection for the multimedia content using a transmission protocol based on which the second user terminal shares the multimedia content, to acquire a detection result may include: parsing the transmission protocol based on which the second user terminal shares the multimedia content to acquire feature information and editing information of photographing the multimedia content; and acquiring the profile information of the multimedia content according to the feature information and the editing information.

The feature information indicates the feature of the profile of the multimedia content. Optionally, the feature information may include at least one of: expression information, action information, audio information, color information and scenario information. For example, the expression information includes disclosure software and/or expression content for the user to photograph and/or edit magic expressions; the action information includes disclosure software and/or action content for the user to photograph and/or edit magic actions; the script information includes disclosure software and/or script content for the user to photograph and/or edit videos; the audio information includes disclosure software and/or audio content for the user to photograph and/or edit audios; the color information includes disclosure software and/or color content for the user to photograph and/or edit videos; and the scenario information includes disclosure software and/or scenario content for the user to photograph and/or edit videos.

The editing information indicates information of editing the multimedia content based on the profile of the multimedia content. Optionally, the editing information may include: information of an disclosure that generates the multimedia content. For example, the editing information may include a photographing disclosure and/or editing disclosure of the multimedia content; optionally, the editing information may further include another similar disclosure that implements photographing and/or editing besides the photographing disclosure and/or editing disclosure of the multimedia content; and further optionally, the editing information may further include a photographing and/or editing means of the multimedia content, for example, exposure duration, aperture selection, color adjustment, personage and space allocation, photographing angle, light selection, personage action or the like.

The multimedia content profile information may be acquired based on the above feature information and editing information. With respect to the manner of receiving the multimedia content, local multimedia content may be generated according to the acquired profile information, or elements of the received multimedia content or the multimedia content to be generated may be edited according to the profile information, or elements of the multimedia content to be generated may be firstly photographed according to the acquired profile information and then the elements may be correspondingly edited according to the profile information, or the profile information may be firstly edited and then elements of the multimedia content to be generated are edited, and finally the local multimedia content may be generated. In this way, it is unnecessary for the multimedia content receiving party to download and/or install a corresponding program or disclosure for generating the multimedia content, which mitigates load of the user, and improves the efficiencies of generating, interacting and sharing the multimedia content.

For example, a multimedia content receiving party parses the transmission protocol to acquire the profile information corresponding to the magic expression video, for example, including information of the photographing disclosure and photographing means for generating the magic expression video, and expression content. The multimedia content receiving party is capable of logging in to the server according to the profile information to photograph the same magic expression video by using the photographing means without installing the photographing and/or editing disclosure. Further, the photographed magic expression video may also be shared to other users. Nevertheless, the other users may also select to download the disclosure for photographing and/or editing the magic expression to the local to implement photographing and/or editing of the magic expression video.

Still for example, the multimedia content receiving party parses the transmission protocol to acquire the profile information corresponding to the script video, for example, including information of the photographing disclosure and photographing means for generating the script video, and script content. The multimedia content receiving party is capable of logging in to the server according to the profile information to photograph the same video by using the photographing means according to the script without installing the photographing and/or editing disclosure. Further, the photographed video may also be shared to other users. Nevertheless, the other users may also select to download the disclosure for photographing and/or editing to the local to implement photographing and/or editing of the video.

Further, optionally, in addition to the profile information detection for the multimedia content, the target detection may further include: a target object detection for the multimedia content. The target object may be appropriately defined by a person skilled in the art according to the actual needs, for example, detection for entirety or face or expression or action or the like of the human body, detection for an animal, detection for a scenario or background or the like, which is not limited in the embodiment of the present disclosure.

Step S206: The first user terminal generates an AR object according to the target detection result and an image acquired by the first user terminal.

After the corresponding target detection result is acquired, the AR object may be generated according to the target detection result and the image acquired by the first user terminal.

In a first possible implementation manner, a detection result of profile information in the target detection result may be used as a first detection result, and using a detection result of the target object as a second detection result; a detection for the target object (which is the same as the target object of the multimedia content, for example, both the human body, or both the face, or both the expression or action or the like) is performed in the images acquired by the first user terminal to acquire a third detection result; and the second detection result is replaced with the third detection result, and the AR object is generated according to the second detection result upon replacement and the first detection result. In this manner, new multimedia content having a style close to the style of the shared multimedia content, such that interest of the shared multimedia content is improved.

In a second possible implementation manner, a detection result of profile information in the target detection result may be used as a fourth detection result; a detection for the target object is performed in the images acquired by the first user terminal to acquire a fifth detection result; and the AR object is generated according to the fourth detection result and the fifth detection result. In this manner, the target object detection may not be performed, and matched target object detection is performed in the images acquired by the first user terminal according to the profile information. Nevertheless, the target object detection may be still performed for the multimedia content, and the target object detection is likewise performed for the images acquired by the first user terminal. The profile information may be more effectively matched by performing the target object detection for the images acquired by the first user terminal, and thus interaction effects between users may be improved. Nevertheless, in some occasions, the target object detection may be not performed for the images acquired by the first user terminal. In this manner, the profile information of the multimedia content only needs to be detected. This mitigates the detection workload of a multimedia content receiving party, and improves the sharing efficiency of the multimedia content and the generation efficiency of the AR object.

In a third possible implementation manner, a detection result of profile information in the target detection result as a sixth detection result; a detection for the target object in the images acquired by the first user terminal to acquire a seventh detection result; a first AR object is generated according to the sixth detection result and the seventh detection result; and a second AR object is generated according to the first AR object and the multimedia content. Similar to the above manner, in this manner, the target object may be performed or may be not performed for the multimedia content. Different from the above two manners, in this manner, the locally generated first AR object is combined with the shared multimedia content, the detection result of the profile information is used as the sixth detection result; and the target object detection is performed for the images acquired by the first user terminal to generate the second AR object which is richer in content. In this way, interaction effects between users are further improved.

In a fourth possible implementation manner, a detection result of profile information in the target detection result is used as an eighth detection result; a modify request for the eighth detection result is received, wherein the modify request carries a modification parameter; the eighth detection result is modified according to the modify request to acquire a modification result; a detection for the target object is performed in the images acquired by the first user terminal to acquire a ninth detection result; and the AR object is generated according to the modification result and the ninth detection result. For example, content in the profile information, such as one or some of the feature information, may be modified via a corresponding interface, to generate new feature information. Hence, based on the modified profile information, the AR object is generated according to the detection result of the target object in the images acquired. In this manner, interest and interacting ability of the multimedia content are enhanced.

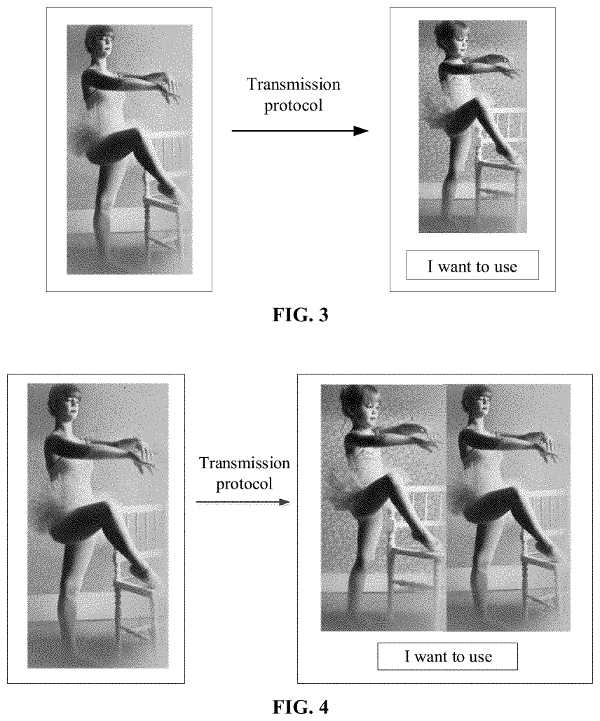

Based on the above description, when the first possible implementation manner is employed, a schematic diagram of a multimedia content processing result is as illustrated in FIG. 3. In FIG. 3, the image on the left side is the multimedia content shared by the second user terminal, corresponding first human body information is acquired by performing an object detection for the multimedia content, and corresponding profile information is acquired by performing a profile information detection for the multimedia content. Hence, a human body detection is performed for the images acquired by the first user terminal to acquire second human body information in the images. Afterwards, the first human body information is replaced with the second human body information, and new multimedia content is generated in combination with the profile information, as illustrated by the images on the left side in FIG. 3.

When the second possible implementation manner is employed, a multimedia data processing result is the same as that illustrated in FIG. 3. However, in this manner, the human body detection is only performed for the images acquired by the first user terminal; and hence, the multimedia content as illustrated in the left side in FIG. 3 is generated by combining the second human body information with the profile information.

When the third possible implementation manner is employed, a schematic diagram of a multimedia data processing result as illustrated in FIG. 4. In FIG. 4, the image on the left side is the multimedia content shared by the second user terminal, and corresponding profile information is acquired by performing a profile information detection the multimedia content. Afterwards, a human body detection is performed for the images acquired by the first user terminal to acquire second human body information in the images. Subsequently, a new image (as illustrated in the left part of the images on the right side in FIG. 4) is generated by combining the human body information in the image with the profile information. Finally, the generated new image is combined with the image shared by the second user terminal to generate a final image (a complete image on the right side in FIG. 4)

However, the practice is not limited to the above description. In practical disclosure, according to the actual needs, a person skilled in the art may employ other suitable manners of generating the AR object according to the profile information and the target object detection result. In addition, in some manners, the profile information detection may be only performed for the multimedia content, and the profile information may be directly combined with the images acquired by the first user terminal. In this way, it is not only unnecessary to perform the target object detection for the multimedia content, but also unnecessary to perform the target object detection for the images acquired by the first user terminal, to improve the generation efficiency of the AR object. However, through the target object detection, the target object may be better combined with the profile information, and the effect and interacting ability of the generated AR object are both better.

Step S208: The first user terminal exhibits the generated AR object.

The generated AR object may be locally exhibited, or may be shared to a specific or a non-specific range, to further improve the interaction effects between the users.

According to this embodiment, a first user terminal performs a target detection, including a profile information detection, for multimedia content to acquire a corresponding target detection result (including profile information of the multimedia content), and thus a corresponding AR object is generated according to an image acquired by the first user terminal and the target detection result. The profile information may indicate information of a multimedia profile used when the second user terminal generates the multimedia content. Through the profile information, feature information such as expressions, emotions, scenarios and the like that are shared by a user of the second user terminal via the multimedia content may be acknowledged, such that a user of the first user terminal photographs more suitable or matched images, and generates an AR object similar to or matching a style of the shared multimedia content. In this way, a better expression effect is achieved, interactions between users may be implemented via the AR object, and interaction effects may be improved.

The method for processing multimedia data according to this embodiment may be performed by any device having the data processing capability, including, but not limited to: various terminal devices or servers, for example, PCs, tablet computers, mobile terminals or the like.

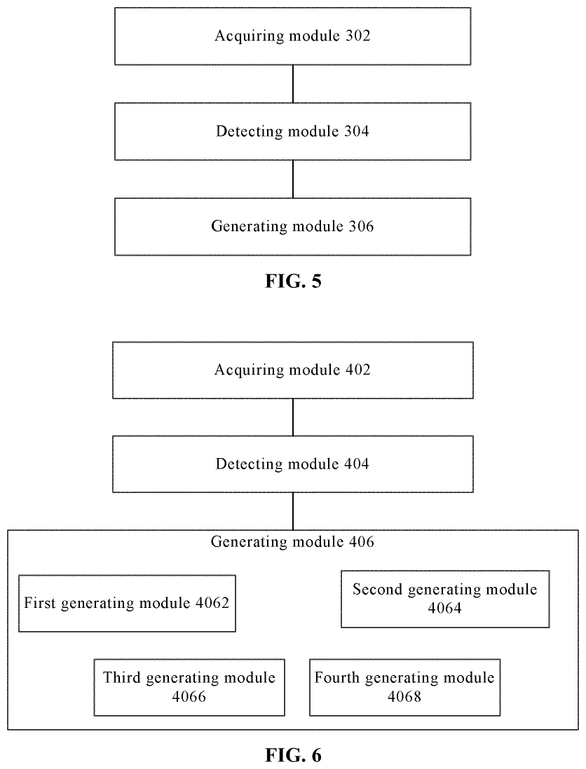

FIG. 5 is a schematic structural diagram of an apparatus for processing multimedia data according to a third embodiment of the present disclosure.

The apparatus for processing multimedia data is arranged in a first user terminal. The apparatus includes: an acquiring module 302 that is configured to acquire multimedia content shared by a second user terminal; a detecting module 304 that is configured to perform a target detection for the multimedia content to acquire a target detection result. The target detection includes a profile information detection for the multimedia content; and a generating module 306 that is configured to generate an augmented reality (AR) object according to the target detection result and an image acquired by the first user terminal, and exhibit the AR object.

FIG. 6 is a schematic structural diagram of an apparatus for processing multimedia data according to a fourth embodiment of the present disclosure.

The apparatus for processing multimedia data is arranged in a first user terminal. The apparatus includes: an acquiring module 402 that is configured to acquire multimedia content shared by a second user terminal; a detecting module 404 that is configured to perform a target detection for the multimedia content to acquire a target detection result. The target detection includes a profile information detection for the multimedia content; and a generating module 406 that is configured to generate an augmented reality (AR) object according to the target detection result and an image acquired by the first user terminal, and exhibit the AR object.

Optionally, the target detection further includes a target object detection for the multimedia content.

Optionally, the generating module 406 includes: a first generating module 4062 that is configured to: use a result of the profile information detection in the target detection result as a first detection result, and use a result of the target object detection as a second detection result; perform a detection for the target object in the image acquired by the first user terminal to acquire a third detection result; replace the second detection result with the third detection result, and generate the AR object according to the second detection result upon replacement and the first detection result; and exhibit the AR object.

Optionally, the generating module 406 includes: a second generating module 4064 that is configured to: use a result of the profile information detection in the target detection result as a fourth detection result; perform a detection for the target object in the image acquired by the first user terminal to acquire a fifth detection result; and generate the AR object based on the fourth detection result and the fifth detection result;

Or the generating module 406 includes a third generating module 4066 that is configured to: use a detection result of the profile information detection in the target detection result as a sixth detection result; perform a detection for the target object in the image acquired by the first user terminal to acquire a seventh detection result; generate a first AR object according to the sixth detection result and the seventh detection result; and generate a second AR object according to the first AR object and the multimedia content;

Or the generating module 406 includes a fourth generating module 4068 that is configured to use a detection result of the profile information detection in the target detection result as an eighth detection result; receive a modify request for the eighth detection result, wherein the modify request carries a modification parameter; modify the eighth detection result based on the modify request to acquire a modification result; perform a detection for the target object in the image acquired by the first user terminal to acquire a ninth detection result; and generate the AR object according to the modification result and the ninth detection result.

Optionally, the detecting module 402 is further configured to perform a profile information detection for the multimedia content using a transmission protocol based on which the second user terminal shares the multimedia content, to acquire a detection result.

Optionally, the detecting module 402 is further configured to parse the transmission protocol based on which the second user terminal shares the multimedia content, to acquire feature information and editing information of photographing the multimedia content; and acquire the profile information of the multimedia content based on the feature information and the editing information.

Optionally, the feature information comprises at least one of: facial expression information, action information, script information, audio information, color information, and scenario information.

Optionally, the editing information includes information of a disclosure that generates the multimedia content.

The apparatus for processing multimedia data of the embodiment may be used to implement the corresponding methods for processing multimedia data which are described in the previous embodiments, and achieve similar technical benefits, which will not be repeated for brevity.

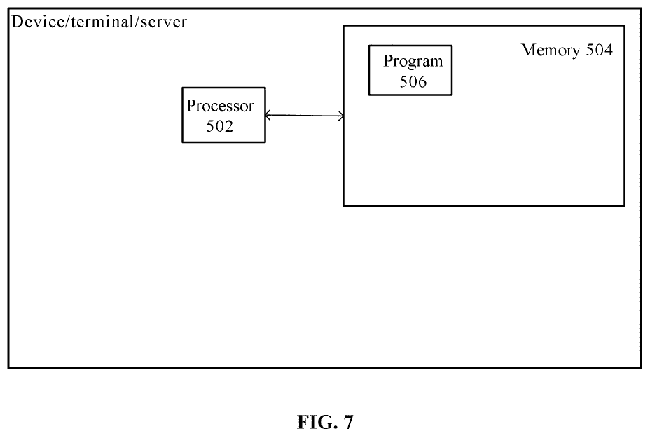

FIG. 7 is a schematic structural diagram of a device/terminal/server according to the fifth embodiment of the present disclosure is given. However, the embodiment of the present disclosure sets no limitation on specific practice of the device/terminal/server.

As illustrated in FIG. 7, the device/terminal/server may include: a processor 502, and a memory 504.

The processor 502 is configured to execute a program 506 to specifically perform the related steps in the method for processing multimedia data.

Specifically, the program 506 may include a program code, wherein the program code includes a computer-executable instruction.

The processor 502 may be a central processing unit (CPU) or an Disclosure Specific Integrated Circuit (ASIC), or configured as one or more integrated circuits for implementing the embodiments of the present disclosure. The device/terminal/server includes one or more processors, which may be the same type of processors, for example, one or more CPUs, or may be different types of processors, for example, one or more CPUs and one or more ASICs.

The memory 504 is configured to store one or more programs 506. The memory 504 may include a high-speed RAM memory, or may also include a non-volatile memory, for example, at least one magnetic disk memory.

Specifically, the program 506 may drive the processor 502 to perform the following operations: a first terminal acquires multimedia content shared by a second user terminal; perform a target detection for the multimedia content to acquire a target detection result. The target detection includes a profile information detection for the multimedia content; and generate an augmented reality object based on the target detection result and an image acquired by the first user terminal, and exhibiting the AR object.

In another embodiment, the target detection further includes: a target object detection for the multimedia content.

In another embodiment, when the program 506 drives the processor to generate an augmented reality object based on the target detection result and an image acquired by the first user terminal, the program 506 may also drive the processor 502 to: use a detection result of profile information in the target detection result as a first detection result, and use a detection result of the target object as a second detection result; perform a detection for the target object in the image acquired by the first user terminal to acquire a third detection result; replace the second detection result with the third detection result, and generate the AR object according to the second detection result upon replacement and the first detection result; and generate the AR object.

In another embodiment, when the program 506 drives the processor to generate an augmented reality object based on the target detection result and an image acquired by the first user terminal, the program 506 may also drive the processor 502 to: use a detection result of profile information in the target detection result as a fourth detection result; perform a detection for the target object in the image acquired by the first user terminal to acquire a fifth detection result; and generate the AR object according to the fourth detection result and the fifth detection result. or the program 506 may also drive the processor 502 to: use a detection result of profile information in the target detection result as a sixth detection result; perform a detection for the target object in the image acquired by the first user terminal to acquire a seventh detection result; generate a first AR object according to the sixth detection result and the seventh detection result; and generate a second AR object according to the first AR object and the multimedia content. Or the program 506 may also drive the processor 502 to: a fourth generating module, configured to use a detection result of profile information in the target detection result as an eighth detection result; receive a modify request for the eighth detection result, wherein the modify request carries a modification parameter; modify the eighth detection result according to the modify request to acquire a modification result; perform a detection for the target object in the image acquired by the first user terminal to acquire a ninth detection result; and generate the AR object according to the modification result and the ninth detection result.

In another embodiment, when the program 506 drives the processor 502 to perform the target object detection for the multimedia content, the program 506 may also drive the processor 502 to: perform profile information detection for the multimedia content and acquire a detection result based on the transmission protocol with which the second user terminal shares the multimedia content.

In another embodiment, when the program 506 drives the processor 502 to perform a profile information detection for the multimedia content using a transmission protocol based on which the second user terminal shares the multimedia content and acquire a detection result, the program 506 may also drive the processor 502 to: parse the transmission protocol based on which the second user terminal shares the multimedia content, acquire feature information and editing information of photographing the multimedia content; and acquire the profile information of the multimedia content based on the feature information and the editing information.

In another embodiment, the feature information comprises at least one of: facial expression information, action information, script information, audio information, color information, and scenario information.

In another embodiment, the editing information comprises: information of a disclosure that generates the multimedia content.

Specific practice of various steps in program 506 may be referenced to the description of related steps and units in the above embodiment illustrating the method for processing multimedia data. A person skilled in the art would clearly acknowledge that for ease and brevity of description, the specific operation processes of the above described devices and modules may be referenced to the relevant portions in the above described method embodiments, which are thus not described herein any further.

With the device/terminal/server, the first terminal performs a target detection for the multimedia content, acquires a target detection result (including profile information of the multimedia content), and generates an AR object based on the target detection result and an image acquired by the first user terminal. The profile information indicates the information of the multimedia profile used by the second terminal in generating the multimedia content. Through the profile information, feature information such as facial expressions, emotions, scenarios and the like that are shared by a user of the second terminal via the multimedia content may be obtained, such that a user of the first user terminal generates an AR object similar to or matching a style of the shared multimedia content. In this way, a better expression effect is achieved, interactions between users may be implemented via the AR object, and interaction effects may be improved.

It should be noted that the devices/steps in the embodiments described above may be separated into more devices/steps based on needs in implementing the embodiments. On the other hand, two or more of the devices/steps may be recombined into new forms of devices/steps to achieve the object of this disclosure. In particular, the processes or methods described in the flowcharts can be implemented by software. For instance, an embodiment of the disclosure includes a product of a computer program, including a computer program carried by a computer-readable medium. The computer program includes program codes for executing the methods described in the embodiments related to the methods. In such an embodiment, the computer program may be downloaded from online via a communication channel and installed, and/or installed from a detachable medium. When the computer program is executed by a central processing unit (CPU), the above functions defined in the methods according to the present disclosure are implemented. It should be noted that the computer-readable medium according to the present disclosure may be a computer-readable signal medium or a computer-readable storage medium or any combination thereof. The computer-readable medium may be, but not limited to, for example, electrical, magnetic, optical, electromagnetic, infrared or semiconductor systems, apparatuses or devices, or any combination thereof. More specific examples of the computer-readable storage medium may include, but not limited to: an electrical connection having one or more conducting wires, a portable computer magnetic disk, a hard disk, a random access memory (RAM), a read-only memory (ROM), an erasable programmable read-only memory (ERROM), an optical fiber, a portable compact disc read-only memory (CD-ROM or flash memory), an optical storage device, a magnetic storage device, or any combination thereof. In the present disclosure, the computer-readable storage medium may be any tangible medium including or storing a program. The program may be used by an instruction execution system, apparatus, device or any combination thereof. In the present disclosure, a computer-readable signal medium may include a data signal in the baseband or transmitted as a portion of a carrier wave, and the computer-readable signal medium bears computer-readable program code. Such a transmitted data signal may be, but not limited to, an electromagnetic signal, optical signal or any suitable combination thereof. The computer-readable signal medium may be any computer-readable medium in addition to the computer-readable storage medium. The computer-readable medium may send, spread or transmit the program which is used by the instruction execution system, apparatus, device or any combination thereof. The program code included in the computer-readable medium may be transmitted via any suitable medium, which includes, but is not limited to, wireless manner, electric wire, optical fiber, RF and the like, or any suitable combination thereof.

One or more programming languages or any combination thereof may be used to execute the computer program code operated in the present disclosure. The programming languages include object-oriented programming languages, for example, Java, Smalltalk and C++, and further include ordinary procedural programming languages, for example, C language or similar programming languages. The program code may be totally or partially executed by a user computer, or may be executed as an independent software package, or may be partially executed by a user computer and partially executed by a remote computer, or may be totally executed by the remote computer or a server. In the scenario involving a remote computer, the remote computer may be connected to the user computer via any type of network, including a local area network (LAN) or a wide area network (WAN), or may be connected to an external computer (for example, connecting to the external computer via the Internet provided by an Internet service provider).

The flowcharts and block diagrams in the accompanying drawings illustrate possibly practicable system architecture, functions and operations of the system, method and computer program product according to various embodiments of the present disclosure. In this sense, each block in the flowcharts or block diagrams may represent a module, a program segment or a portion of the code. The module, the program segment or the portion of the code includes one or more executable instructions for implementing specified logic functions. Specific sequence relationships are present in the above specific embodiments. However, these sequence relationships are merely exemplary, fewer and more steps may be performed or the sequence for performing these steps may be adjusted or changed. It should be noted that in some alternative implementations, the functions specified in the blocks may also be implemented in a sequence different from that illustrated in the accompanying drawings. For example, two continuous blocks may be practically performed substantially in parallel, and sometimes may be performed in a reverse sequence, which may depend on the functions involved. It should also be noted that each block in the block diagrams and/flowcharts and a combination of the blocks of the block diagrams and/or flowcharts may be implemented by using a dedicated hardware-based system for implementing the specified functions or operations, or may be implemented by using a combination of dedicated hardware and computer instructions.

The units involved in the embodiments of the present disclosure may be implemented by means of software or hardware. The described units may also be configured in a processor. The units may be described as follows: a processor includes an acquiring unit, a detecting unit and a generating unit. In some scenarios the names of these units do not provide any limit the units. For instance, the acquiring unit may be described as “a unit for acquiring the multimedia content which is separated by the second user terminal”.

In another aspect, an embodiment of the present disclosure further provides a computer-readable medium in which a computer program is stored. The computer program implements the method as described in any one of the above embodiments when being executed by a processor.

In still another aspect, an embodiment of the present disclosure further provides a computer-readable medium. The computer-readable medium may be incorporated in the apparatus as described in the above embodiments, or may be arranged independently, not incorporated in the apparatus. One or more programs are stored in the computer-readable medium. When the one or more programs are executed by the apparatus, the apparatus is instructed to: acquire multimedia content shared by a second user terminal; perform a target detection for the multimedia content and acquire a target detection result, wherein the target detection comprises a profile information detection for the multimedia content; and generate an augmented reality object according to the target detection result and an image acquired by the first user terminal, and exhibiting the AR object.

Described above are merely preferred exemplary embodiments of the present disclosure and illustration of the technical principle of the present disclosure. A person skilled in the art should understand that the scope of the present disclosure is not limited to the technical solution defined by a combination of the above technical features, and shall further cover the other technical solutions defined by any combination of the above technical features and equivalent features thereof without departing from the inventive concept of the present disclosure. For example, the scope of the present disclosure shall cover the technical solutions defined by interchanging between the above technical features and the technical features having similar functions disclosed (but not limited to those disclosed) in the present disclosure.

What is claimed is:

1. A method for processing multimedia data, comprising:
acquiring, by a first user terminal, multimedia content shared by a second user terminal;
performing a target detection for the multimedia content to acquire a target detection result, wherein the target detection comprises a profile information detection for the multimedia content; and
generating an augmented reality object according to the target detection result and an image acquired by the first user terminal, and exhibiting an augmented reality object.

2. The method according to claim 1, wherein the target detection further comprises: a target object detection for the multimedia content.

3. The method according to claim 2, wherein the generating an augmented reality object according to the target detection result and an image acquired by the first user terminal comprises:
using a detection result of profile information in the target detection result as a first detection result, and using a detection result of the target object as a second detection result; performing a detection for the target object in the image acquired by the first user terminal to acquire a third detection result; and replacing the second detection result with the third detection result, and generating the an augmented reality object according to the second detection result upon replacement and the first detection result.

4. The method according to claim 1, wherein the generating an augmented reality object according to the target detection result and an image acquired by the first user terminal comprises:
using a detection result of profile information in the target detection result as a fourth detection result; performing a detection for the target object in the image acquired by the first user terminal to acquire a fifth detection result; and generating the augmented reality object according to the fourth detection result and the fifth detection result; or
using a detection result of profile information in the target detection result as a sixth detection result; performing a detection for the target object in the image acquired by the first user terminal to acquire a seventh detection result; generating a first augmented reality object according to the sixth detection result and the seventh detection result; and generating a second augmented reality object according to the first augmented reality object and the multimedia content; or
using a detection result of profile information in the target detection result as an eighth detection result; receiving a modify request for the eighth detection result, wherein the modify request carries a modification parameter; modifying the eighth detection result according to the modify request to acquire a modification result; performing a detection for the target object in the image acquired by the first user terminal to acquire a ninth detection result; and generating the augmented reality object according to the modification result and the ninth detection result.

5. The method according to claim 1, wherein the performing a target detection for the multimedia content to acquire a target detection result comprises:
performing a profile information detection for the multimedia content using a transmission protocol based on which the second user terminal shares the multimedia content, to acquire a detection result.

6. The method according to claim 5, wherein the performing a profile information detection for the multimedia content using a transmission protocol based on which the second user terminal shares the multimedia content, to acquire a detection result comprises:
parsing the transmission protocol based on which the second user terminal shares the multimedia content, to acquire feature information and editing information of photographing the multimedia content; and
acquiring the profile information of the multimedia content according to the feature information and the editing information.

7. The method according to claim 6, wherein the feature information comprises at least one of: expression information, action information, script information, audio information, color information, and scenario information.

8. The method according to claim 6, wherein the editing information comprises: information of an application that generates the multimedia content.

9. An apparatus for processing multimedia data, arranged in a first user terminal; wherein the apparatus comprises:
an acquiring module, configured to acquire multimedia content shared by a second user terminal;
a detecting module, configured to perform a target detection for the multimedia content to acquire a target detection result, wherein the target detection comprises a profile information detection for the multimedia content; and
a generating module, configured to generate an augmented reality object according to the target detection result and an image acquired by the first user terminal, and exhibit the augmented reality object.

10. The apparatus according to claim 9, wherein the target detection further comprises: a target object detection for the multimedia content.

11. The apparatus according to claim 10, wherein the generating module comprises:
a first generating module, configured to: use a detection result of profile information in the target detection result as a first detection result, and use a detection result of the target object as a second detection result; perform a detection for the target object in the image acquired by the first user terminal to acquire a third detection result; replace the second detection result with the third detection result, and generate the augmented reality object according to the second detection result upon replacement and the first detection result; and generate the augmented reality object.

12. The apparatus according to claim 9, wherein the generating module comprises:
a second generating module, configured to: use a detection result of profile information in the target detection result as a fourth detection result; perform a detection for the target object in the image acquired by the first user terminal to acquire a fifth detection result; and generate the augmented reality object according to the fourth detection result and the fifth detection result; or
a third generating module, configured to: use a detection result of profile information in the target detection result as a sixth detection result; perform a detection for the target object in the image acquired by the first user terminal to acquire a seventh detection result; generate a first augmented reality object according to the sixth detection result and the seventh detection result; and generate a second augmented reality object according to the first augmented reality object and the multimedia content; or
a fourth generating module, configured to use a detection result of profile information in the target detection result as an eighth detection result; receive a modify request for the eighth detection result, wherein the modify request carries a modification parameter; modify the eighth detection result according to the modify request to acquire a modification result; perform a detection for the target object in the image acquired by the first user terminal to acquire a ninth detection result; and generate the augmented reality object according to the modification result and the ninth detection result.

13. The apparatus according to claim 9, wherein the detecting module is further configured to perform a profile information detection for the multimedia content using a transmission protocol based on which the second user terminals shares the multimedia content, to acquire a detection result.

14. The apparatus according to claim 13, wherein the detecting module is further configured to parse the transmission protocol based on which the second user terminal shares the multimedia content, to acquire feature information and editing information of photographing the multimedia content; and acquire the profile information of the multimedia content according to the feature information and the editing information.

15. The apparatus according to claim 14, wherein the feature information comprises at least one of: expression information, action information, script information, audio information, color information, and scenario information.

16. The apparatus according to claim 14, wherein the editing information comprises: information of an application that generates the multimedia content.

17. A device, comprising:
one or more processors; and
a non-transitory storage memory, configured to store instructions;
wherein the instructions, when being executed by the one or more processors, cause the one or more processors to:
acquire, by a first user terminal, multimedia content shared by a second user terminal;
perform a target detection for the multimedia content to acquire a target detection result, wherein the target detection comprises a profile information detection for the multimedia content; and
generate an augmented reality object according to the target detection result and an image acquired by the first user terminal, and exhibiting an augmented reality object.
